(19) United States
(12) Patent Application Publication
(10) Pub. No.: US 2015/0042709 A1
(43) Pub. Date: Feb. 12, 2015

(54) LIQUID EJECTING APPARATUS

(71) Applicant: Seiko Epson Corporation, Tokyo (JP)

(72) Inventor: Kyohei DATE, Shiojiri (JP)

(21) Appl. No.: 14/449,447

(22) Filed: Aug. 1, 2014

(30) Foreign Application Priority Data
Aug. 8, 2013 (JP) 2013-164904

(51) Int. Cl. B41J 2/045

(52) U.S. Cl. CPC B41J 2/04541; B41J 2/04581
USPC 347/10

(57) ABSTRACT

A liquid ejecting apparatus includes a first piezo-electric element; a first cavity; a first nozzle; a second piezo-electric element; a second cavity; a second nozzle; a drive signal generating section which generates a drive signal causing the first piezo-electric element or the second piezo-electric element to be displaced; a drive signal transmission path through which the drive signal is transmitted from the drive signal generating section to the first piezo-electric element or the second piezo-electric element; and a cable that forms at least a portion of the drive signal transmission path, the cable includes a drive signal transmitting wire which forms at least a portion of the drive signal transmission path and a shield wire in which potentials are fixed, and the drive signal transmitting wire has a characteristic impedance in a predetermined range.

The entire disclosure of Japanese Patent Application No. 2013-164904, filed Aug. 8, 2013 is expressly incorporated by reference herein.

### BACKGROUND

1. Technical Field

The present invention relates to a liquid ejecting apparatus that ejects liquid by applying a drive signal to an actuator and that is appropriate, for example, for a liquid ejecting-type printing apparatus that prints predetermined characters, images, or the like by ejecting minute liquid from a nozzle of a liquid ejecting head, and forming minute particles (dots) on a printing medium.

2. Related Art

Signal transmission cables to perform transmission of signals between circuit boards of electronic apparatuses are used. Among the cables, a flexible flat cable (FFC) in which conducting wires are arranged at a predetermined interval on a plane is widely used because of the thinness or flexibility. For example, the liquid ejecting-type printing apparatus has to transmit a drive signal from a controller to an actuator of a liquid ejecting head, and a flexible flat cable is widely used to connect the controller and the liquid ejecting head.

Here, for example, the liquid ejecting-type printing apparatus can generate a drive signal to be transmitted to a liquid ejecting head by amplifying a modulated pulse signal by a digital power amplification circuit and then smoothening the pulse signal. In this case, since noises generated in the generation process of a drive signal and disturbance noises may resonate so that the correct ejection of the liquid may be disturbed, it is preferable to use the flexible flat cable that performs a sufficient suppression of noise.

In the invention of JP-A-2008-290387, disclosed is a liquid ejecting apparatus including a first cable including a ground wire group in which ground wires continuously run parallel among a plurality of transmission wires which run parallel in a predetermined direction, and a second cable which is arranged to face the first cable, in which a plurality of transmission wires run parallel in a predetermined direction, and in which transmission wires of changing voltage are arranged to face an area including a ground wire group. In the invention of JP-A-2008-290387, even if there is a relative deviation between overlapped cables, a shield effect on the transmission wires of changing voltage can be exhibited.

However, if the liquid ejecting-type printing apparatus is a line head printer, the number of nozzles of the liquid ejecting head becomes greater compared to a serial printer. Thus, the transmission rates of the drive signal and the control signal increase. Therefore, if the invention of JP-A-2008-290387 is applied to the line head printer without any change, multiple flexible flat cables have to be overlapped so that the sliding property may be decreased. Further, if the thickness of the flexible flat cable is increased, the size of the liquid ejecting-type printing apparatus may also increase.

### SUMMARY

An advantage of some aspects of the invention is to provide a liquid ejecting apparatus including a cable that can sufficiently perform suppression of noise and deal with a case in which the transmission rate of a signal is great.

(1) According to an aspect of the invention, there is provided a liquid ejecting apparatus including: a first piezo-electric element; a first cavity which is filled with liquid, and in which pressure is increased and decreased by displacement of the first piezo-electric element; a first nozzle which communicates with the first cavity, and ejects the liquid as a droplet by increasing or decreasing pressure in the first cavity; a second piezo-electric element; a second cavity which is filled with liquid, and in which pressure is increased and decreased by displacement of the second piezo-electric element; a second nozzle which communicates with the second cavity, and ejects the liquid as droplets by increasing or decreasing pressure in the second cavity; a drive signal generating section which generates a drive signal causing the first piezo-electric element or the second piezo-electric element to be displaced; a drive signal transmission path through which the drive signal is transmitted from the drive signal generating section to the first piezo-electric element or the second piezo-electric element; and a cable that forms at least a portion of the drive signal transmission path, the cable includes a drive signal transmitting wire which forms at least a portion of the drive signal transmission path and a shield wire in which potentials are fixed, and the drive signal transmitting wire has a characteristic impedance in a predetermined range.

According to the liquid ejecting apparatus of the aspect of the invention, since the cable includes a shield wire, and has a characteristic impedance in a predetermined scope, the decrease of the ejection stability caused by the noise provided in a drive signal can be prevented. Therefore, for example, high speed printing can be performed in the liquid ejecting apparatus such as the line head printer in which multiple nozzles are driven at the same time.

(2) Further, the drive signal may be an analog signal of continuously changing voltage.

If the drive signal that causes piezo-electric elements to be displaced is an analog signal, the influence of the noise on the drive signal directly influences the displacement of the piezo-electric elements. For example, if the voltage of the drive signal to which the noise is provided when the droplets are ejected is applied to the piezo-electric elements, the piezo-electric elements are irregularly displaced and the amounts of ejected liquid are irregularly changed. Thus, for example, the image quality of the printed image is decreased in the liquid ejecting-type printing apparatus.

According to the liquid ejecting-type printing apparatus, the decrease of the ejection stability caused by the noise provided in a drive signal can be prevented. Therefore, if the drive signal is the analog signal, and the influence on the noise is directly led to the decrease of quality (image quality), the prominent effect of preventing the deterioration can be obtained.

Further, according to the liquid ejecting apparatus, since a cable having a characteristic impedance in a predetermined scope is used, it is possible to suppress influence such as the attenuation in the analog signal and the cable can be designed without specifically considering the length of the path.

(3) Further, the liquid ejecting apparatus may include a control signal generating section that generates a control signal to control whether to apply the drive signal to the first piezo-electric element or the second piezo-electric element; a control signal transmission path through which the control signal is transmitted from the control signal generating section to the first piezo-electric element or the second piezo-electric element, the cable may include control signal transmitting wire that forms at least a portion of the control signal transmission path, and the control signal transmitting wire may have a characteristic impedance in a predetermined range.

According to the liquid ejecting apparatus, since the cable has the shield wire, and has the characteristic impedance in the predetermined scope, it is possible to prevent the erroneous ejection caused by the noise provided in the control signal. Therefore, for example, highly reliable printing can be performed in the liquid ejecting apparatus such as the line head printer in which multiple nozzles are driven at the same time.

(4) Further, the control signal transmitting wire and drive signal transmitting wire may have the characteristic impedance in the predetermined range which corresponds to a terminal resistor provided in a head section.

According to the liquid ejecting apparatus, since the cable has the characteristic impedance which corresponds to the terminal resistor provided in the head section, it is possible to suppress the deterioration of the control signal caused by, for example, signal reflection.

(5) Further, the cable may cause the control signal to be transmitted to the head section in a differential serial method.

According to the liquid ejecting apparatus, it is possible to transmit several control signals in series by using the differential serial method. In this case, it is possible to decrease the number of required transmission wires compared to the transmission of each control signal in the single end method. Therefore, it is possible to avoid the increase of the thickness by the overlapping of the cables to decrease the sliding property, and decrease a size of a connector.

(6) Further, the cable may be capable of causing the control signals to be transmitted at a speed of 3 Gbps or greater.

According to the liquid ejecting apparatus, it is possible to transmit the control signal which is the digital signal in a GHz order by using a method of, for example, Low Voltage Differential Signaling (LVDS) or Low-Voltage Positive Emitter-Coupled Logic (LVPECL). Therefore, for example, it is possible to perform high speed printing in the liquid ejecting apparatus such as the line head printer in which multiple nozzles are driven at the same time.

(7) Further, the cable may have the characteristic impedance in the predetermined range from 90 to 110 ohms.

According to the liquid ejecting apparatus, for example, it is appropriate to use a differential serial method called LVDS having a terminal resistance of 100 ohms. Here, if the lower limit of the characteristic impedance of the cable can cover the range of about 80 ohms, the cable can be applied, for example, to a USB having a terminal resistance of 90 ohms.

(8) Further, the cable may be a flexible cable, and the cable may have a characteristic in which the number of times of sliding is 500,000 or more.

According to the liquid ejecting apparatus, even if there is a movable head section, for example, such as the head unit of the printer, the cable connected to the head section has the sliding property of 500,000 times or more. Therefore, the cable has sufficient durability (wear resistance), and the quality of the liquid ejecting apparatus can be enhanced.

(9) Further, the liquid ejecting apparatus may be a line head printer.

It is required to transmit data to the head section at a high rate in the liquid ejecting apparatus such as the line head printer in which multiple nozzles are driven at the same time. In the high rate data transmission, even if the noise is minute, a plurality of items of data are negatively influenced, and a plurality of nozzles that is driven based on the data erroneously eject ink, and thus a crucial defect may be generated on a product material. The liquid ejecting apparatus of the aspect of the invention is the line head printer, but highly reliable data can be transmitted to the head section at a high rate by using the cable, and thus printing of a high quality at a high speed can be performed.

### BRIEF DESCRIPTION OF THE DRAWINGS

The invention will be described with reference to the accompanying drawings, wherein like numbers reference like elements.

FIG. 1 is a block diagram illustrating an overall configuration of a printing system.

FIG. 2 is a cross section schematically illustrating a printer.

FIG. 3 is a plan view schematically illustrating the printer.

FIG. 4 is a diagram illustrating a structure of a head.

FIG. 5 is a graph illustrating drive signals COM from a drive signal generating section and control signals used to form dots.

FIG. 6 is a block diagram illustrating a configuration of a head controller.

FIG. 7 is a diagram illustrating an exemplary connection of a cable between a controller and a head unit.

FIG. 8 is a perspective view illustrating a portion of the cable.

FIG. 9 is a diagram illustrating transmission of a control signal in a differential serial method.

FIG. 10 is a table in which cables used in the evaluation are compared.

FIGS. 11A to 11B are graphs illustrating a comparison between a line head printer and a serial printer.

### DESCRIPTION OF EXEMPLARY EMBODIMENTS

### 1. Configuration of Printing System

As an embodiment of a liquid ejecting apparatus of the invention, a liquid ejecting apparatus applied to a liquid ejecting printing apparatus is described.

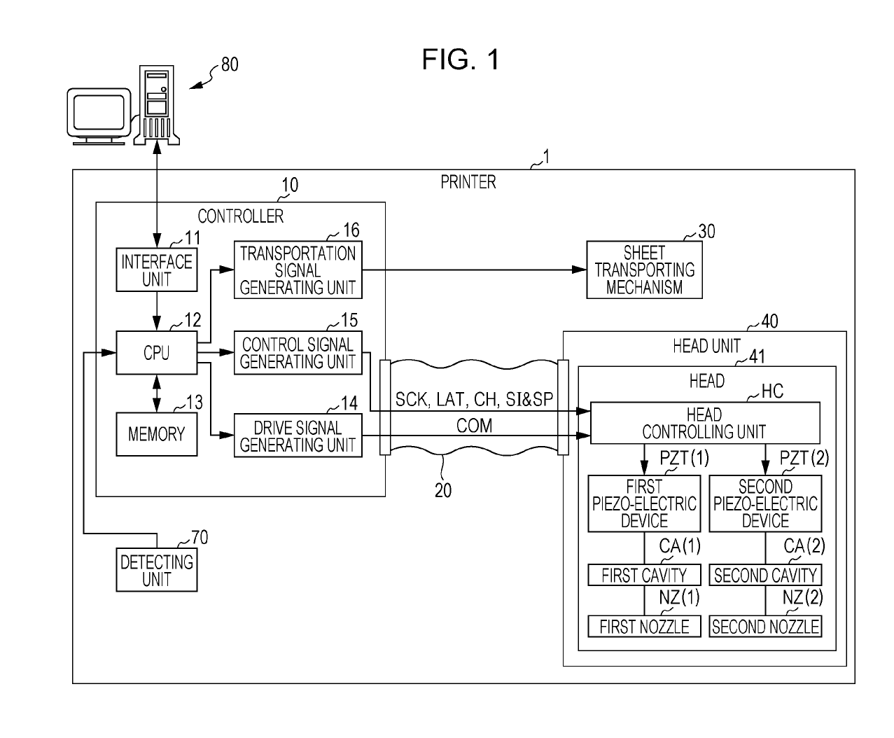

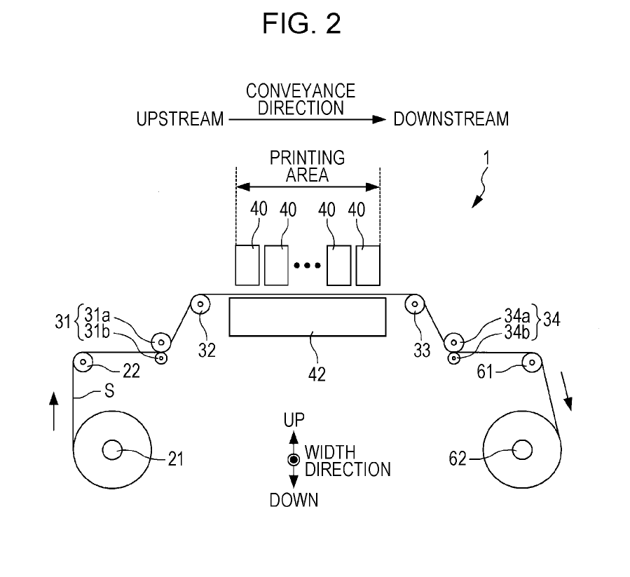

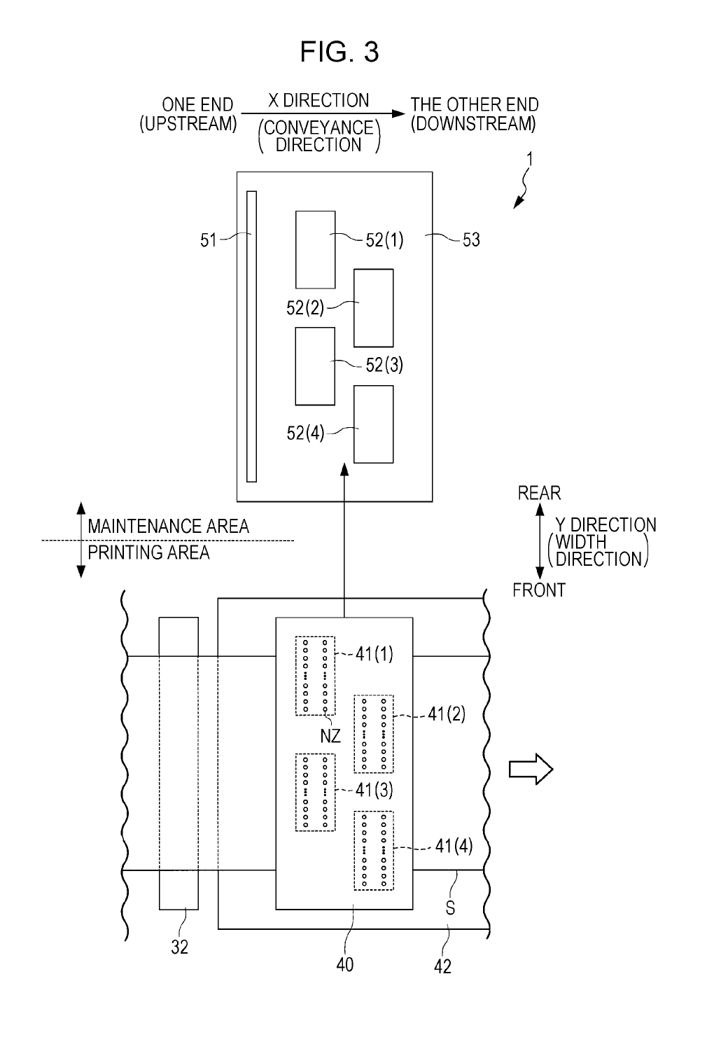

FIG. 1 is a block diagram illustrating an overall configuration of a printing system including a liquid ejecting printing apparatus (a printer 1) according to an embodiment of the invention. As described below, the printer 1 is a line head printer in which a sheet S (see FIGS. 2 and 3) is transported in a predetermined direction and printing is performed on a printing area in the middle of the transportation.

In the printer 1, a printer driver which is communicably connected to a computer 80 and installed in the computer 80 creates data for printing an image on the printer 1 and outputs the created image to the printer 1. The printer 1 includes a controller 10, the sheet transporting mechanism 30, a head unit 40, and a detector group 70. Further, the printer 1 may include the plurality of head units 40 as described below, but the head units will be represented by one head unit 40 with reference to FIG. 1. Further, the head unit 40 corresponds to the head section of the invention, but when the printer 1 includes the plurality of head units 40, the set of the head unit 40 corresponds to the head section of the invention.

The controller 10 in the printer 1 is to generally control the printer 1. An interface section 11 performs transmission and reception of data with the computer 80 which is an external apparatus. A CPU 12 is a calculating processor that generally controls the printer 1, and controls the head unit 40 and a sheet transporting mechanism 30 through a drive signal generating section 14, a control signal generating section 15, and a transportation signal generating section 16. A memory 13 is to secure an area to store a program of the CPU 12, a working area, or the like. A state in the printer 1 is monitored by the detector group 70, and the controller 10 performs control based on a detection result from the detector group 70.

The drive signal generating section 14 generates a drive signal COM that displaces a piezo-electric element PZT included in a head 41. The drive signal generating section 14 may include, for example, a portion of a source signal generating circuit, a modulation circuit, a digital power amplification circuit, a smoothing filter (all the elements are not illustrated). In this case, the drive signal generating section 14 generates a source signal in the source signal generating circuit according to the instruction from the CPU 12, generates a modulation signal by performing pulse modulation on a source signal in the modulation circuit, amplifies a modulation signal in the power amplification circuit, and generates the drive signal COM by smoothing the amplified modulation signal in the smoothing filter.

The control signal generating section 15 generates a control signal according to the instruction from the CPU 12. The control signal is, for example, a signal used in the control of the head 41 to select an ejecting nozzle. According to the embodiment, the control signal generating section 15 generates control signals including a clock signal SCK, a latch signal LAT, a channel signal CH, and driving pulse selecting data SI & SP, but detailed description of the signals will be presented below. Further, the control signal generating section 15 may be a configuration to be included in the CPU 12 (that is, a configuration in which the CPU 12 also serves a function of the control signal generating section 15).

Here, the drive signal COM generated by the drive signal generating section 14 is an analog signal of continuously changing voltage. The control signals of the clock signal SCK, the latch signal LAT, the channel signal CH, and the driving pulse selecting data SI & SP are digital signals. The drive signal COM and the control signals are transmitted to the head 41 of the head unit 40 through a cable 20 which is a flexible flat cable (hereinafter, also referred to as an FFC). Here, with respect to the control signals, a plurality of kinds of signals are transmitted using a differential serial method in a time sharing manner as described below. Therefore, compared to the case of transmitting the control signals for each kind in parallel, it is possible to decrease the number of required transmission wires, so that the decrease of the sliding property caused by the overlapping of multiple FFCs is avoided, and a size of a connector provided in the controller 10 and the head unit 40 is decreased.

The transportation signal generating section 16 generates a signal for controlling the sheet transporting mechanism 30 according to the instruction from the CPU 12. For example, the sheet transporting mechanism 30 rotatably supports the continuing sheet S wound in a roll shape and transports the sheet S by rotation, and causes predetermined characters, images, or the like to be printed on the printing area. For example, the sheet transporting mechanism 30 transports the sheet S in a predetermined direction based on a signal generated in the transportation signal generating section 16. Further, the transportation signal generating section 16 may be a configuration to be included in the CPU 12 (that is, a configuration in which the CPU 12 also serves a function of the transportation signal generating section 16).

The head unit 40 includes the head 41 as a liquid ejecting section. Due to lack of space, only one head 41 is illustrated in FIG. 1, but the head unit 40 according to the embodiment includes the plurality of heads 41. The head 41 includes at least two actuator sections, each of which includes the piezo-electric element PZT, a cavity CA, a nozzle NZ, and a head controller HC that controls displacement of the piezo-electric element PZT. The actuator section includes the piezo-electric element PZT which can be displaced by the drive signal COM, the cavity CA which is filled with liquid and of which internal pressure is increased or decreased by the displacement of the piezo-electric element PZT, and the nozzle NZ which communicates with the cavity CA and which ejects the liquid as droplets by the increasing or the decreasing of the pressure in the cavity CA. The head controller HC controls the displacement of the piezo-electric element PZT based on the drive signal COM and the control signals from the controller 10.

Here, if the elements included in each actuator section are distinguished, numbers with parentheses are attached to reference numerals. In the example of FIG. 1, there are two actuator sections: the first actuator section includes the first piezo-electric element PZT(1), the first cavity CA(1), and the first nozzle NZ(1), and the second actuator section includes the second piezo-electric element PZT(2), the second cavity CA(2), and the second nozzle NZ(2). The drive signal COM is generated from the drive signal generating section 14 illustrated in FIG. 1, and transmitted to the first piezo-electric element PZT(1) or the second piezo-electric element PZT(2) through the cable 20 and the head controller HC, but the path corresponds to a drive signal transmission path of the invention. Further, the control signals including a clock signal SCK, a latch signal LAT, a channel signal CH, and driving pulse selecting data SI & SP are generated in the control signal generating section 15 as illustrated in FIG. 1, and transmitted to the first piezo-electric element PZT(1) or the second piezo-electric element PZT(2) through the cable 20 and the head controller HC, but the path corresponds to a control signal transmission path of the invention. The cable 20 according to the embodiment forms at least a portion of the drive signal transmission path, and also forms at least a portion of the control signal transmission path.

### 2. Configuration of Printer

FIG. 2 is a cross section schematically illustrating the printer 1. In the example of FIG. 2, the sheet S is described as continuous paper wound in a roll shape, but a recording medium on which the printer 1 prints an image is not limited to the continuous paper, and the recording medium may be cut paper, cloth, or a film.

The printer 1 includes a rolling shaft 21 that feeds the sheet S by rotation, and a relay roller 22 that rolls the sheet S fed from the rolling shaft 21 and guides the sheet S to a pair of upstream transporting rollers 31. Then, the printer 1 includes the plurality of relay rollers and 33 that roll the sheet S, the pair of upstream transporting rollers 31 arranged on an upstream side of the printing area in the transportation direction, and a pair of downstream transporting rollers 34 arranged on a downstream side of the printing area in the transportation direction. The pair of upstream transporting rollers 31 and the pair of downstream transporting rollers 34 each include driving rollers 31a and 34a which are connected to a motor (not illustrated) and perform driving rotation, and the driven rollers 31b and 34b that rotate according to the rotation of the driving rollers 31a and 34a. Then, transportation force is applied to the sheet S by the driving rotation of the driving rollers 31a and 34a in a state in which the pair of upstream transporting rollers 31 and the pair of downstream transporting rollers 34 respectively interpose the sheet S. The printer 1 includes a relay roller 61 that rolls the sheet S transmitted from the pair of downstream transporting rollers 34, and a winding driving shaft 62 that rolls the sheet S transmitted from the relay roller 61. The printed sheet S is sequentially rolled in a roll shape according to the driving rotation of the winding driving shaft 62. Further, the rollers and the motor (not illustrated) correspond to the sheet transporting mechanism 30 of FIG. 1.

The printer 1 includes the head unit 40, and a platen 42 that supports the sheet S from the surface opposite to the printed surface in the printing area. The printer 1 may include the plurality of head units 40. For example, the printer 1 may be prepared with the head units 40 for each ink color, or may have a configuration in which four head units 40 capable of discharging ink in four colors of yellow (Y), magenta (M), cyan (C), and black (K) run parallel in the transportation direction.

As illustrated in FIG. 3, the plurality of heads 41(1) to 41(4) run parallel in the width direction (Y direction) of the sheet S that intersects the transportation direction of the sheet S in each of the head units 40. Further, for the sake of description, smaller numbers are sequentially given from the heads 41 on the rear side of the Y direction. Further, the multiple nozzles NZ that eject ink run parallel on the surfaces (undersurfaces) of the respective head 41 which are opposite to the sheet S in the Y direction at a predetermined interval. Further, FIG. 3 is a diagram virtually illustrating positions of the heads 41 and the nozzles NZ when the head units 40 are seen from above. The nozzles NZ on the end portions of the heads 41 (for example, the heads 41(1) and 41(2)) that are adjacent to each other in the Y direction are positioned so as to be at least partially overlapped with each other, and the nozzles NZ run parallel at a predetermined interval in the Y direction in a range of the width of the sheet S or longer on the undersurfaces of the head units 40. Accordingly, the head units 40 eject ink from the nozzles NZ to the transported sheet S without stopping under the head units 40 so that a two-dimensional image is printed on the sheet S.

Further, four heads 41 included in the head unit 40 are illustrated in FIG. 3 due to lack of space, but the invention is not limited thereto. That is, more or less than four of the heads 41 may be included. Further, the heads 41 are arranged in a zigzag grid manner in FIG. 3, but the invention is not limited to the arrangement. Here, a method of ejecting ink from the nozzle NZ is a piezoelectric method of ejecting ink by expansion and contraction of an ink chamber by applying a voltage to the piezo-electric element PZT according to the embodiment, but the method of ejecting ink may be a thermal method of generating bubbles in the nozzle NZ by using a heating element and ejecting ink by the bubbles.

Further, the sheet S is supported on the horizontal surface of the platen 42 according to the embodiment but the invention is not limited thereto. For example, while the rotating drum that rotates about the width direction of the sheet S as a rotating axis is set to be the platen 42, and the sheet S is rolled onto the rotating drum and transported, ink may be ejected from the heads 41. In this case, the head units 40 are arranged in an inclined manner along the outer peripheral surface of the rotating drum in an arc shape. Further, for example, if the ink ejected from the heads 41 is UV ink that is cured by performing irradiation with ultraviolet rays, an irradiation apparatus that performs irradiation with ultraviolet rays may be provided on the downstream side of the head units 40.

Here, the printer 1 includes a maintenance area in order to clean the head units 40. A wiper 51, a plurality of caps 52, and an ink receiving section 53 (hereinafter, these are collectively referred to as a maintenance functional section) are provided on the maintenance area of the printer 1. The maintenance area is positioned on the further rear side in the Y direction than the platen 42 (that is, the printing area), and the head unit 40 is moved to the rear side in the Y direction at the time of cleaning. Further, the maintenance functional area illustrated in FIG. 3 is provided for each head unit 40, and the configuration of the maintenance functional area or the method of cleaning the head unit 40 is the same regardless of ink color. Therefore, the description below is commonly applied.

The wiper 51 and the cap 52 are supported by the ink receiving section 53, and can be moved by the ink receiving section 53 in the X direction (the transportation direction of the sheet S). The wiper 51 is a member provided from the ink receiving section 53, and formed with an elastic member, cloth, felt, or the like. The cap 52 is a rectangular parallelepiped member formed with an elastic member or the like, and is provided for each head 41. Then, the caps 52(1) to 52(4) run parallel in the width direction in accordance with the arrangement of the heads 41(1) to 41(4) on the head unit 40. Accordingly, if the head units 40 move to the rear side in the Y direction, the heads 41 and the caps 52 face each other, and if the head units 40 descend (or the caps 52 ascend), the caps 52 come in close contact with the opening surfaces of the nozzles on the head 41, so that the nozzles NZ can be sealed. The ink receiving section 53 performs a function of receiving ink ejected from the nozzles NZ at the time of cleaning the head 41.

When the ink is ejected from the nozzles NZ provided on the head 41, minute ink droplets are generated together with main ink droplets, and the minute ink droplets soar as mist and become attached on the opening surfaces of the nozzles of the head 41. Further, not only ink but also dust or paper powder is attached on the opening surfaces of the nozzles on the head 41. If these foreign substances are left attached and accumulate on the opening surfaces of the nozzles on the head 41, the nozzles NZ are blocked, and the ejection of the ink from the nozzles NZ is hindered. Therefore, a wiping process of cleaning the head unit 40 is periodically performed in the printer 1 according to the embodiment.

Consequently, the head unit 40 does not move when printing is performed on the sheet S on the printing area, but when maintenance (wiping process) is performed, the head unit 40 moves in the Y direction. Since the wiping process is periodically performed, the cable 20 connected to the head unit 40 has to be selected after fully considering the movement of the head unit 40. That is, the cable 20 that connects the controller 10 and the head unit 40 has to have a high sliding property.

### 3. Drive Signal and Control Signal

Hereinafter, the drive signal COM and the control signals from the controller 10 which are transmitted through the cable 20 are described in detail. First, the structure of the head 41 is described, waveforms of the drive signal COM and the control signals are exemplified, and then a configuration of the head controller HC is described.

3.1. Structure of head

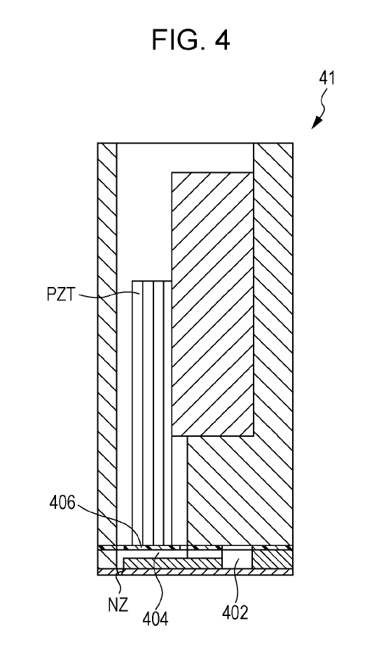

FIG. 4 is a diagram illustrating a structure of the head 41. In FIG. 4, the nozzle NZ, the piezo-electric element PZT, an ink supply passage 402, a nozzle communication passage 404, and an elastic plate 406 are illustrated. The ink supply passage 402 and the nozzle communication passage 404 correspond to the cavity CA.

Ink droplets from an ink tank (not illustrated) are supplied to the ink supply passage 402. Then, the ink droplets are supplied to the nozzle communication passage 404. A driving pulse PCOM of the drive signal COM is applied to the piezo-electric element PZT. If the driving pulse PCOM is applied, the piezo-electric element PZT expands and contracts (caused to be displaced) according to the waveform so that the elastic plate 406 vibrates. Then, the ink droplets in an amount corresponding to the amplitude of the driving pulse PCOM are ejected from the nozzles NZ. Actuator sections including the nozzles NZ, the piezo-electric elements PZT, and the like as described above run parallel as illustrated in FIG. 3 so that the head 41 having a nozzle array is configured.

### 3.2. Waveform of Signal

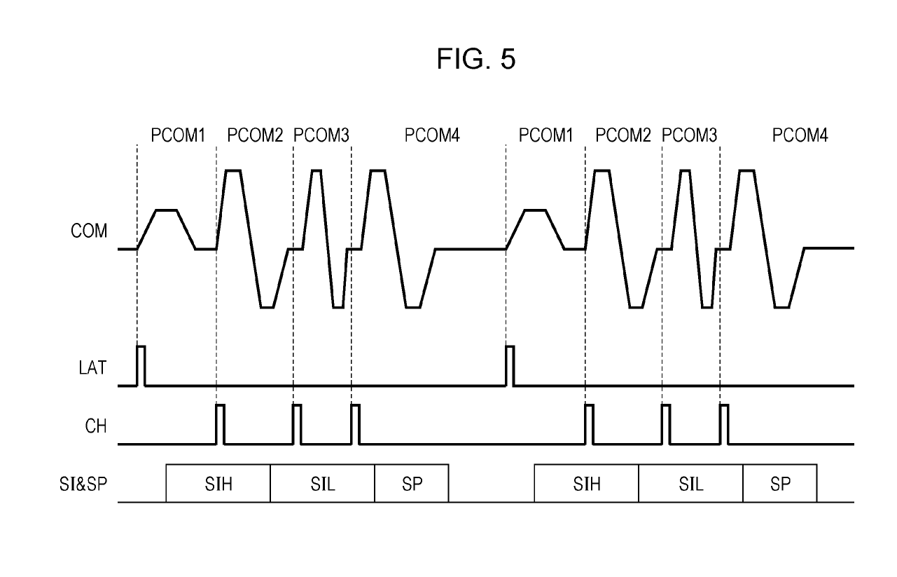

FIG. 5 is a graph illustrating the drive signal COM from the drive signal generating section 14 and control signals used to form dots. The drive signal COM is applied to the piezo-electric element PZT and connects the driving pulse PCOM in time series as a unit drive signal that causes liquid to be ejected. A rising portion of the driving pulse PCOM is a stage of expanding a capacity of the cavity CA communicating with the nozzle and introducing the liquid, and a falling portion of the driving pulse PCOM is a stage of reducing the capacity of the cavity CA and extruding the liquid. As a result of the extrusion of the liquid, the liquid is ejected from the nozzle.

The introduction amount or the introduction speed of the liquid and the extrusion amount and the extrusion speed of the liquid can be changed by variously changing the voltage rising and falling slope or the peak value of the driving pulse PCOM obtained from the trapezoid wave of the voltage, and accordingly the ejection amount of the liquid is changed to obtain different sizes of dots. Consequently, even if the plurality of driving pulses PCOM are connected in time series, various sizes of dots can be obtained by selecting the single driving pulse PCOM from the driving pulses PCOM, applying the single driving pulse PCOM to the piezo-electric element PZT, and ejecting the liquid or by selecting the plurality of driving pulses PCOM, applying the driving pulses PCOM to the piezo-electric element PZT, and ejecting the liquid several times. That is, landing a plurality of droplets of liquid in the same position before the liquid is dried has substantially the same effect of ejecting a large droplet of liquid so that the size of the dot can be increased. Multiple gradations can be obtained by the combination of the techniques described above. Further, a driving pulse PCOM1 on the left end of FIG. 5 is different from the driving pulses PCOM2 to PCOM4, and is not extruded only by the introduction of the liquid. The driving pulse PCOM1 is called a minute vibration, and is used to suppress and prevent the liquid from being thickened in the nozzle without ejecting the liquid.

In addition to the drive signal COM from the drive signal generating section 14, as control signals from the control signal generating section 15, the clock signal SCK, the latch signal LAT, the channel signal CH, and the driving pulse selecting data SI & SP are input to the head controller HC. Among them, the latch signal LAT and the channel signal CH are control signals for determining timing of the drive signal COM. As illustrated in FIG. 5, a series of the drive signals COM are started to be output at the latch signals LAT, and the driving pulses PCOM are output for each channel signal CH. The driving pulse selecting data SI & SP includes pixel data SI (SIH and SIL) for designating the piezo-electric element PZT corresponding to the nozzle intended to cause the ink droplets to be ejected and the waveform pattern data SP of the drive signal COM. The data SIH and SIL respectively correspond to a higher bit and a lower bit of the two-bit pixel data.

### 3.3. Head Controller

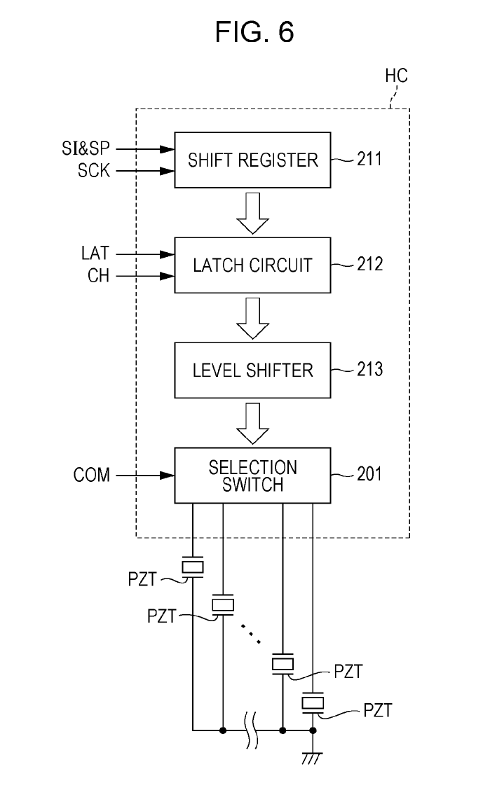

FIG. 6 is a block diagram illustrating a configuration of the head controller HC. The head controller HC is configured to include a shift register 211 that stores the driving pulse selecting data SI & SP to designate the piezo-electric element PZT corresponding to the nozzles that eject the liquid, a latch circuit 212 that temporarily stores data of the shift register 211, and a level shifter 213 that applies the voltage of the drive signal COM to the piezo-electric element PZT by performing level-conversion on the output of the latch circuit 212 and supplying the output to a selecting switch 201.

In the shift register 211, the driving pulse selecting data SI & SP is sequentially input and also a storage area is sequentially shifted from an initial stage to a subsequent stage according to the input pulse of the clock signal SCK. The latch circuit 212 latches each output signal of the shift register 211 by the input latch signal LAT after the driving pulse selecting data SI & SP by the number of nozzles is stored in the shift register 211. The signal stored in the latch circuit 212 is converted by the level shifter 213 into a voltage level capable of turning on and off the selecting switch 201 on the subsequent stage. This is because the drive signal COM is a higher voltage than the output voltage of the latch circuit 212, and accordingly the range of the operation voltage of the selecting switch 201 is set to be high. Consequently, the piezo-electric element PZT in which the selecting switch 201 is closed by the level shifter 213 is connected to the drive signal COM (the driving pulse PCOM) at the connection timing of the driving pulse selecting data SI & SP.

Further, after the driving pulse selecting data SI & SP of the shift register 211 is stored in the latch circuit 212, information on the next printing is input to the shift register 211, and the storage data of the latch circuit 212 is sequentially updated according to the ejection timing of the liquid. Further, after the piezo-electric element PZT is separated from the drive signal COM (the driving pulse PCOM) by the selecting switch 201, the input voltage of the piezo-electric element PZT is maintained at the voltage immediately before the separation.

### 4. Cable

### 4.1. Required Characteristics

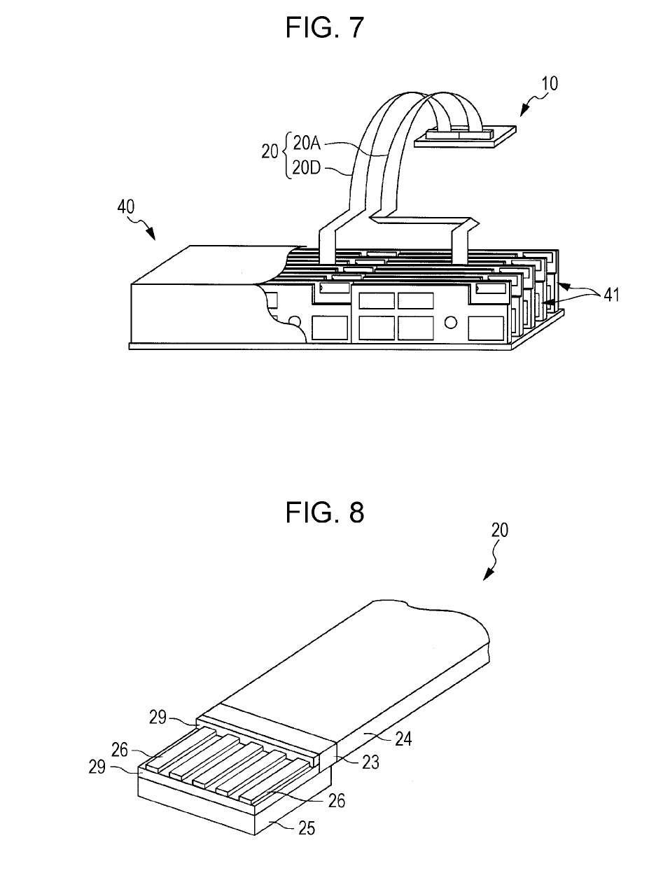

FIG. 7 is a diagram illustrating an exemplary connection of a cable between the controller 10 and the head unit 40. In FIG. 7, the drive signal COM is transmitted through the cable 20A, and the cable 20A forms at least a portion of the drive signal transmission path. Further, in FIG. 7, control signals of the clock signal SCK, the latch signal LAT, the channel signal CH, and the driving pulse selecting data SI & SP are transmitted through the cable 20D, and the cable 20D forms at least a portion of the control signal transmission path. Further, in the example of FIG. 7, the cable 20A and the cable 20D are separately illustrated but the cables may be overlapped or may be integrated into the single cable 20.

The controller 10 and the head unit 40 are not limited to being closely disposed in the printer 1, and the cable 20 may have a certain length (for example, 2 m to 3 m). Accordingly, the cable 20 tends to easily receive disturbance noises, and particularly when the transmission rate of the signal is high, the influence increases. If the data is transmitted to the head section at a high rate, even if a noise is minute, a plurality of items of data are negatively influenced, and a plurality of nozzles that is driven based on the data erroneously eject ink, and thus a crucial defect may be generated on a product material. Further, in the drive signal COM generated through the amplification process in the digital power amplification circuit, noises generated in the generation process (for example, a ripple noise) and disturbance noises may resonate so that the correct ejection of the liquid may be disturbed.

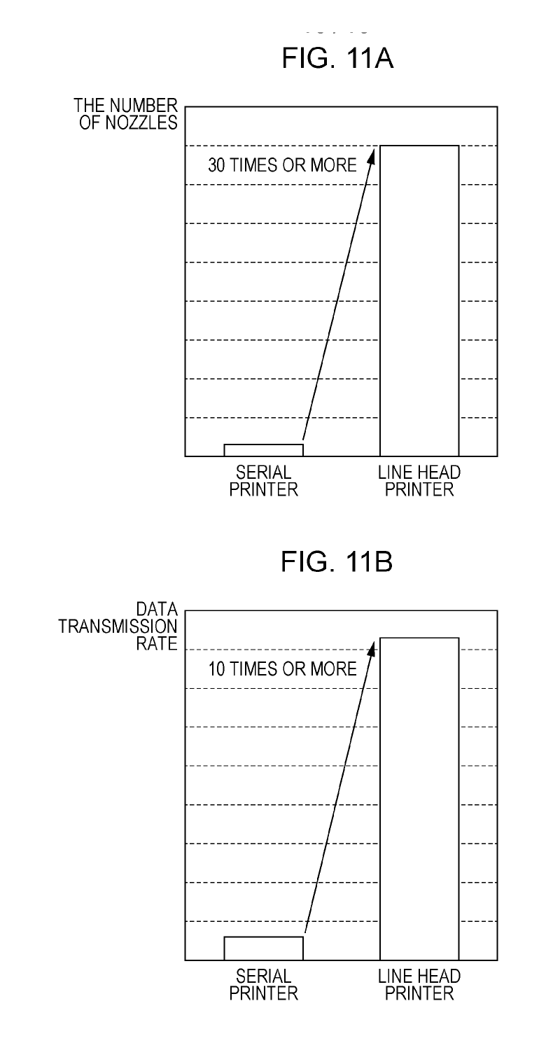

Here, FIGS. 11A to 11B are graphs illustrating comparison between the line head printer and the serial printer. For example, as illustrated in FIG. 11A, the number of nozzles in the line head printer is 30 times or more than that in the serial printer. Then, as illustrated in FIG. 11B, in order to control the head 41 having many nozzles, the data transmission rate of the control signal in the line head printer is 10 times or more than that in the serial printer.

The printer 1 according to the embodiment is the line head printer. Then, with respect to the control signal of the printer 1, it is not practical to increase the number of transmission wires and the number of the terminals corresponding to an increased number of the nozzles. Accordingly, the increase of the numbers of the transmission wires and the terminals has to be suppressed by performing, for example, serial transfer on the control signal. In this case, since the data transmission rate is, for example, in an order of GHz, if the cable 20D receives the influence of the noise as described above, even when the noise is minute, the plurality of nozzles erroneously eject ink so that the reliability of printing is decreased. Further, in the drive signal COM of the printer 1, if the cable 20A receives the influence of the noise, the correct ejection of the liquid may be disturbed as described above, and thus the image quality is directly deteriorated. Furthermore, if the cable 20A is long, the drive signal COM may be attenuated. Therefore, the image quality is deteriorated.

Accordingly, it is not appropriate to employ an FFC (normal FFC described below) which is generally used in a serial printer to the printer 1 which is the line head printer. First, the cable 20 of the printer 1 is required to have sufficient noise resistance. Further, in the cable 20, a signal can be transmitted in a high speed differential serial method, and also a characteristic impedance is required to be sufficiently controlled so that the influence such as the attenuation of an analog signal is suppressed. Furthermore, when the maintenance (wiping process) is performed, the head unit 40 is moved. Therefore, the cable 20 is required to have a high sliding property.

### 4.2. Noise Resistance

First, in order to obtain sufficient resistance, the cable 20 is required to have a shield wire. FIG. 8 is a perspective view illustrating a portion of the cable 20 described above. In FIG. 8, conductors 26 that transmit the drive signal COM or the control signals are arranged in an insulator 29 at a predetermined interval, and a reinforcing plate 25 is provided in a connection portion (connector portion), as commonly configured in a cable without a shield wire (hereinafter, referred to as a normal FFC). However, since the cable 20 is covered with a shield tape 24 including a conductive shield wire inside, and electrically connected to a shield wire exposing section 23 so as to have fixed potentials (for example, ground potential), the cable 20 has the noise resistance. Here, the shield wire does not necessarily have to be linear (that is, wires do not have to run parallel), and conductive thin lines may form a stitch shape, or the metal layer inside the shield tape 24 may be used as the shield wire.

### 4.3. Data Rate

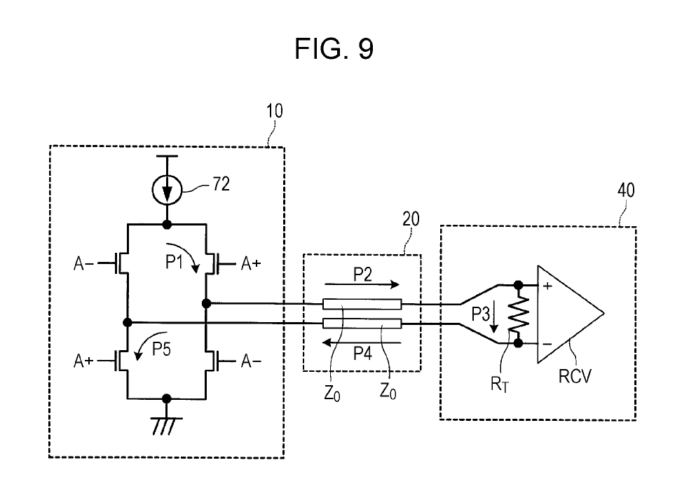

Further, the cable 20 is required to have the sufficiently controlled a characteristic impedance, and to deal with the signal transmission of the differential serial method in a GHz order. FIG. 9 is a diagram illustrating transmission of the control signal in the differential serial method by the cable 20 described above. For example, LVDS is used as the transmission method of the printer 1. In this case, a receiver RCV is included in the head unit 40, and a terminal resistor R_{T} of 100 ohms is provided. Here, the controller 10 transmits the control signal to the head unit 40 by an output driver as illustrated in FIG. 9. Here, reference numerals A+ and A− correspond to a normal rotation signal and a reverse rotation signal of the transmitted control signals, respectively. Further, a current source 72 is a circuit producing a constant current from Vdd.

The cable 20 connects the output driver and the receiver RCV as illustrated in FIG. 9. The cable 20 has a characteristic impedance Z₀. In the connection, for example, currents flow as indicated by reference numerals P1, P2, P3, P4, and P5 of FIG. 9. In this case, for example, in order to suppress the deterioration of the transmission signal such as reflection, the terminal resistor R_{T} has 100 ohms, and thus the cable 20 that connects two resistors of 50 ohms in series is selected. That is, in the example of FIG. 9, impedance matching is obtained by selecting the cable 20 having the characteristic impedance Z₀ of 50 ohms. In this case, the control signal which is the digital signal can be transmitted in the LVDS of the high speed differential serial method. Further, since the cable 20 with the controlled characteristic impedance Z₀ is used, influence such as the attenuation of the drive signal COM which is the analog signal can be suppressed and thus the cable can be designed without specifically considering the length of the path. Further, in the example, the control signal is transmitted in the LVDS, but if a USB having the terminal resistor R_{T} of 90 ohms is used, the cable 20 having the characteristic impedance Zₒ of 45 ohms may be selected.

### 4.4. Evaluation

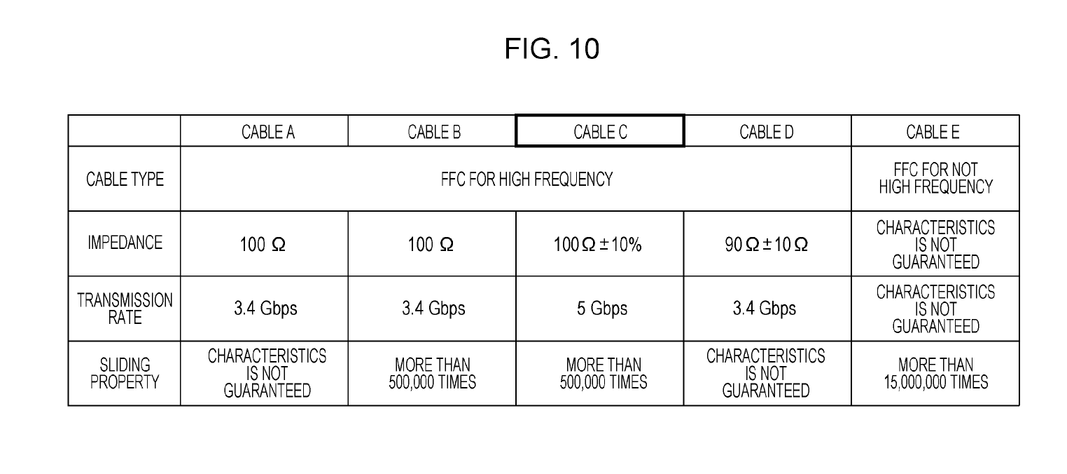

FIG. 10 is a table in which cables used in the evaluation are compared. As presented in FIG. 10, five cables A to E are evaluated, but the cable E is a normal FFC (indicated as an FFC for non-high frequency in FIG. 10), does not have the shield wire, and is prepared for the purpose of comparison with the cables A to D which are candidates of the cable 20. Meanwhile, the cable type of the cables A to D is an FFC for high frequency, and the cables A to D include shield wires, and thus have noise resistance and cause the characteristic impedance to be controlled.

In the evaluation, the LVDS is used to transmit the control signal from the controller 10 to the head unit 40. Accordingly, the terminal resistor R_{T} provided in the head unit 40 has 100 ohms. The characteristic impedance of the cables A to C is controlled to be in a range having a midpoint of 100 ohms, and all of the cables are appropriate. Meanwhile, since the cable D has the characteristic impedance in the range having a midpoint of 90 ohms, the cable D is removed from the candidates of the cable 20 in the evaluation. Further, the impedance of the cables A to D in FIG. 10 is presented with a value obtained from two cables as a pair on the assumption of the differential wire.

Here, since the maximum data rate according to the LVDS standard is 3.125 Gbps, and the transmission rate guaranteed by the cables A to C is 3.4 Gbps (cables A and B) or 5 Gbps (cable C), there is no problem in the cables A to C with respect to the transmission rate.

However, when considering that the maintenance (wiping process) is performed at a regular interval, it is preferable to use a cable that guarantees the sliding property of at least 500,000 times or more. Therefore, the cable A that does not guarantee the characteristic is removed from the candidates of the cable 20.

In the evaluation, a result that the cable B or C is employed as the cable 20 of the printer 1 is obtained. Then, the cable C that guarantees a higher transmission rate among the two cables is most appropriate.

Since the FFC for high frequency having characteristics similar to the cable C is used as the cable of the printer 1, the measure against noise is sufficiently performed, and the printer 1 having a cable that can even deal with a case where the signal transmission rate is large can be provided. Since the cable 20 includes a shield wire, and has a characteristic impedance (for example, 100 ohms in a pair) in a predetermined scope, the decrease of the ejection stability caused by the noise provided in the drive signal COM can be prevented. Therefore, the printer 1 can perform printing of a high quality at a high speed by driving multiple nozzles at the same time in the line head printer. Further, since the control signal can raise the transmission rate by using the differential serial method such as LVDS, it is possible to deal with the line head printer having many nozzles. In addition, since the shield wire is included, it is possible to prevent the erroneous ejection caused by the noise provided in the transmission path. Therefore, the printer 1 can perform printing having the high reliability.

The invention includes a configuration (for example, a configuration having the same function, method, and result, or a configuration having the same advantage and effect) which is substantially the same as those described in the embodiments. Moreover, the invention includes a configuration in which a non-essential portion of the configurations described in the embodiments is replaced. Moreover, the invention includes a configuration providing the same operational effects as those described in the embodiments, or a configuration capable of achieving the same advantages. Moreover, the invention includes a configuration in which a publicly known technique is added to the configurations described in the embodiments.

What is claimed is:

1. A liquid ejecting apparatus comprising:
a first piezo-electric element;
a first cavity which is filled with liquid, and in which pressure is increased and decreased by displacement of the first piezo-electric element;
a first nozzle which communicates with the first cavity, and ejects the liquid as droplets by increasing or decreasing pressure in the first cavity;
a second piezo-electric element;
a second cavity which is filled with liquid, and in which pressure is increased and decreased by displacement of the second piezo-electric element;
a second nozzle which communicates with the second cavity, and ejects the liquid as droplets by increasing or decreasing pressure in the second cavity;
a drive signal generating section which generates a drive signal causing the first piezo-electric element or the second piezo-electric element to be displaced;
a drive signal transmission path through which the drive signal is transmitted from the drive signal generating section to the first piezo-electric element or the second piezo-electric element; and
a cable that forms at least a portion of the drive signal transmission path,
wherein the cable includes a drive signal transmitting wire which forms at least a portion of the drive signal transmission path and a shield wire in which potentials are fixed, and
wherein the drive signal transmitting wire has a characteristic impedance in a predetermined range.

2. The liquid ejecting apparatus according to claim 1,
wherein the drive signal is an analog signal of continuously changing voltage.

3. The liquid ejecting apparatus according to claim 1, further comprising:
a control signal generating section that generates a control signal to control whether to apply the drive signal to the first piezo-electric element or the second piezo-electric element; and
a control signal transmission path through which the control signal is transmitted from the control signal generating section to the first piezo-electric element or the second piezo-electric element,
wherein the cable includes a control signal transmitting wire that forms at least a portion of the control signal transmission path, and
wherein the control signal transmitting wire has a characteristic impedance in a predetermined range.

4. The liquid ejecting apparatus according to claim 3,
wherein the control signal transmitting wire and drive signal transmitting wire have the characteristic impedance in the predetermined range which corresponds to a terminal resistor provided in a head section.

5. The liquid ejecting apparatus according to claim 4,
wherein the cable causes the control signal to be transmitted to the head section in a differential serial method.

6. The liquid ejecting apparatus according to claim 4,
wherein the cable is capable of causing the control signals to be transmitted at a speed of 3 Gbps or greater.

7. The liquid ejecting apparatus according to claim 1,
wherein the cable has the characteristic impedance in the predetermined range from 90 to 110 ohms.

8. The liquid ejecting apparatus according to claim 1,
wherein the cable is a flexible cable, and
the cable has a characteristic in which the number of times of sliding is 500,000 or more.

9. The liquid ejecting apparatus according to claim 1,
wherein the liquid ejecting apparatus is a line head printer.
